(19) United States
(12) Patent Application Publication
(10) Pub. No.: US 2007/0020448 A1
(43) Pub. Date: Jan. 25, 2007

(54) Cavitated film structures

(76) Inventors: Michael Anthony Hubbard, Pittsford, NY (US); Robert M. Sheppard, Victor, NY (US); Dan-Cheng Kong, Fairport, NY (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/187,559

(22) Filed: Jul. 22, 2005

(51) Int. Cl. B32B 3/26; B32B 9/00; B32B 5/20; B32B 27/00

(52) U.S. Cl. 428/304.4; 428/318.4; 428/318.8; 428/319.7

(57) ABSTRACT

A multilayer film structure, including (i) a core layer, wherein the core layer comprises a propylene polymer and is beta-cavitated, and preferably comprises a beta-nucleating agent and (ii) a first skin layer, wherein the first skin layer comprises a polar polymer. Optionally, the film further comprises a first intermediate layer (iii) between the core layer (i) and the first skin layer (ii). Embodiments may have the advantage of the benefits of a beta-cavitated film without the typical increase in permeability or water vapor transmission rates typically associated with beta-cavitated films.

### FIELD OF THE INVENTION

This invention relates to cavitated film structures that may be useful as high-barrier films.

### BACKGROUND OF THE INVENTION

A technique for modifying a polymer film structure and rendering it opaque is to include a cavitating agent in a layer thereof. For example, certain organic, e.g., a polyester, such as polyethylene terephthalate (PET) or polybutylene terephthalate (PBT), or inorganic, e.g., calcium carbonate (CaCO₃), cavitating agents may be included in a layer of a polymer film structure. The presence of the cavitating agent in a layer of a film structure during orientation of the film structure induces voids in the polymeric material of the layer. The voids scatter light thereby causing the film structure to be at least somewhat opaque. The voids also impart the film structure with at least some permeability to gas and moisture. Another technique for cavitating films is by converting beta-form polypropylene to alpha-form polypropylene. Films cavitated by conversion of beta-form polypropylene to alpha-form polypropylene are also known to exhibit at least some opacity and may possess relatively significant permeability rates to gas and moisture.

### SUMMARY OF THE INVENTION

In an aspect, the invention features a film structure. The film structure includes a core layer having first and second sides. The core layer contains a propylene polymer and is cavitated by beta cavitation. The film structure also preferably includes a first intermediate layer having first and second sides. In embodiments possessing an intermediate layer, the first side of the first intermediate layer is preferably on the second side of the core layer. The film structure further includes a first skin layer having first and second sides. The first side of the first skin layer is on a side of the core layer, preferably on the second side of the core layer and when the intermediate layer is present, the first skin layer is on the second side of the first intermediate layer. The first skin layer contains a polar polymer.

In another aspect, the invention features a laminated film structure. The laminated film structure includes a first film structure. The first film structure contains a core layer having first and second sides. The core layer contains a propylene polymer and is cavitated by beta-cavitation, preferably with a beta-nucleating agent as a cavitating agent. The first film structure further contains a first skin layer having first and second sides. The first side of the first skin layer may be positioned on the second side of the core layer. The first skin layer comprises a polar polymer. The first film structure also preferably contains a first intermediate layer having first and second sides and when present is positioned between the core layer and the first skin layer. The first side of the first intermediate layer may be on the second side of the core layer. The laminated film structure also includes an adhesive layer on the second side of the first skin layer. The laminated film structure further includes a second structure on the adhesive layer. The second structure may be a monolayer or multilayer film structure, or the second structure may be another material such as, for example, paper.

One or more of the following features may also be included in the film structures and laminated film structures of the invention.

The structures may preferably have a light transmission of less than 50%. The core layer may further contain an optional secondary cavitating agent, such as a conventional cavitating agent. One or more intermediate layers in addition to the first intermediate layer may be disposed between the core layer and the first skin layer. The structures may further contain a second skin layer on the side of the core layer opposite the first skin layer. One or more intermediate layers may be disposed between the core layer and the second skin layer.

The structures may be biaxially oriented and preferably have been oriented from 4 to 6 times in the machine direction and from 4 to 10 times in the transverse direction.

The structures may have a water vapor transmission rate (WVTR) of less than 6.0 (g/[m²·day]). One or both outer surfaces of the structures may be metallized, surface-treated, and/or coated with a coating. Metallized structures may have a WVTR of less than 0.20 (g/[m²·day]) and an oxygen transmission rate (OTR) of less than 1.5 (cm³/[m²·day·atm]).

The adhesive of the laminated film structures may contain a low-density polyethylene.

The invention provides a beta-cavitated core, polymer film structure, comprising a polar-polymer-containing surface layer. Certain embodiments of the invention provide a cavitated polymer film structure comprising a core layer that is both beta-cavitated and conventionally cavitated. Certain embodiments of the invention demonstrate low water vapor transmission. Certain embodiments of the invention contain a vapor-deposited layer of a metal, e.g., aluminum, on the polar polymer layer and possess superior odor, moisture, and/or gas barrier properties. Thus, some embodiments of the invention may have one or more of the following advantages.

Film structures of the invention also may have uniform opacity, a low density and improved mechanical properties, e.g., enhanced stiffness. In embodiments including both a beta-nucleating agent and an optional secondary cavitating agent in the core layer, the invention may take advantage of a previously unknown synergy between the beta-nucleating agent and the secondary cavitating agent. The use of a beta-nucleating agent in the core layer to cavitate the film structures may also reduce the phenomenon of “plate-out” as can happen with conventional cavitating agents. In addition, the beta-nucleating agent in the core layer may be less likely to adversely react with a component of the polar polymer containing skin layer than a conventional cavitating agent. Furthermore, the polar polymer of the first skin layer may provide a mechanism for reducing the WVTR and gas permeability in applications where high barrier properties are desirable.

### DETAILED DESCRIPTION OF THE INVENTION

“Core layer” as used herein refers to the only layer of a monolayered film or either an inner layer or the thickest layer of a multilayered film.

It will be understood that when a layer is referred to as being “directly on” another layer, no intervening layers are present. On the other hand, when a layer is referred to as being “on” another layer, intervening layers may or may not be present. Similarly, when a layer is referred to as being “between” two reference layers, additional layers may also be between the two reference layers and the subject intermediate layer is not necessarily “directly on” or “directly engaged with” either of the reference layers.

The film structures include a core layer. The core layer may include a propylene polymer. The terms “propylene polymer” and “polypropylene” as used herein include homopolymers as well as copolymers of propylene wherein a copolymer not only includes polymers of propylene and another monomer, but also terpolymers, etc. The propylene content of the copolymers comprises at least 10 wt. % of propylene units, preferably at least 50 wt. % and in many embodiments at least 80 wt. % propylene units in the copolymer. In many preferred embodiments, the propylene polymer of the core layer is a propylene homopolymer.

The propylene polymer of the core layer preferably has an isotacticity ranging from about 80 to 100%, preferably greater than 84%, most preferably from about 85 to 99%, as measured by ¹³C NMR spectroscopy using meso pentads. A mixture of isotactic propylene polymers may be used. Preferably, the mixture contains at least two propylene polymers having different m-pentads. Preferably, the difference between m-pentads is at least 1%. Furthermore, the propylene polymer of the core layer preferably has a melt flow ratio ranging from about 2 to about 10 g/10 minutes, most preferably from about 3 to about 6 g/10 minutes, as measured according to ASTM D1238 at 230° C. under a load of 2.16 kg.

Commercially available propylene polymers for the core layer include PP4612E2 and PP4712E1, which are isotactic propylene homopolymers available from ExxonMobil Chemical Company (Houston, Tex.).

The core layer is also beta-cavitated, meaning at least a majority by volume of the opacifying voids in the core layer are created by beta-cavitation, through the conversion of beta-form polypropylene to alpha-form polypropylene. As used herein, the terms “beta-cavitated” and “beta-cavitation” mean that the layer comprises voids or cavities that are created by first causing the formation of at least some beta-form propylene polymer or polypropylene crystals within the polymer layer during cooling of the polymer melt following extrusion. Commonly, remaining portions of the polymer crystals form as alpha-form propylene crystals. After formation of the beta-form polypropylene crystals, through the addition of heat and/or stress during orientation, at least a portion of the beta-form propylene polymer or polypropylene crystals are converted to alpha-form polypropylene crystals. The alpha-form crystals are more dense and occupy less volume than the beta-form crystals, resulting in a small void remaining following conversion to the alpha-form. In films according to this invention, sufficient numbers of the beta-form polypropylene crystals are converted to alpha-form polypropylene crystals to create a majority by volume of pores or cavities within the core layer that are derived from beta- to alpha-conversion and are thus beta-cavitated cavities.

For purposes of this disclosure, the term “majority” means an amount equal to or greater than about 50%, up to and including 100%. The terms “at least some” and “at least a portion” mean an amount greater than one percent, up to and including 100%.

A preferred method for inducing precipitation of at least a majority by volume and preferably substantially all of the beta-form polypropylene crystals in the core layer is through inclusion of a nucleating agent (also commonly referred to as a “beta-nucleator,” “beta-crystalline nucleating agent” or “beta-nucleating agent”) within the polymer melt to provide a situs for initiation of beta-form crystal growth. The combination of the propylene polymer and the beta-nucleating agent produces a cavitated film with uniform opacity via the conversion process described in the preceding paragraph. Any commonly known beta-nucleating agent may be used for films according to this invention. Other techniques are also known for creating beta-form polypropylene crystals, including controlled gradient cooling of the extruded melt, and may be suitable for use with this invention.

The preferred method for creating at least a majority and preferably substantially all of the voids in the core layer is via conversion of beta-form to alpha-form polypropylene. In embodiments where at least a majority by volume but less than all of the voids are created by beta-cavitation, the remaining voids are created by other cavitation techniques, such as by using conventional cavitating agents and techniques during orientation.

U.S. Pat. No. 4,386,129 to Jacoby and U.S. Pat. No. 4,975,469 to Jacoby disclose processes of forming a film containing nucleating agents to produce beta-form spherulites and then selectively extracting the beta-spherulites. Both Jacoby patents disclose quinacridone compounds, bisodium salts of o-phthalic acids, aluminum salts of 6-quinizarin sulfonic acid and isophthalic and terephthalic acids as beta-nucleating agents.

U.S. Pat. No. 5,681,922 to Wolfschwenger, et al. discloses the use of dicarboxylic acid salts of metals of the second main group of the Periodic Table as beta-nucleating agents.

A two component beta-nucleating agent may be used as the beta-nucleating agent. For example, U.S. Pat. No. 5,231,126 to Shi, et al. discloses the use of a mixture of a dibasic organic acid and an oxide, hydroxide or salt of a metal of group IIA of the Periodic Table.

U.S. Pat. Nos. 5,491,188 and 6,235,823, and EP 0 632 095, each to Ikeda, et al., disclose the use of certain types of amide compounds as beta-nucleating agents.

U.S. Pat. No. 6,005,034 to Hayashida, et al. discloses various types of beta-nucleating agents.

U.S. Pat. Nos. 4,386,129; 4,975,469; 5,681,922; 5,231,126; 5,491,188; 6,235,823; and 6,005,034; as well as EP 0 632 095; are herein incorporated by reference.

Preferably, the beta-nucleating agent is a two component beta-nucleating agent formed by mixing Components A and B. Component A may be an organic dibasic acid, such as pimelic acid, azelaic acid, o-phthalic acid, terephthalic and isophthalic acid and the like. Component B may be an oxide, hydroxide or an acid salt of a Group II metal, e.g., magnesium, calcium, strontium and barium. The acid salt of Component B may come from inorganic or organic acid such as carbonate, stearate, etc. Component B may also be an additive of polypropylene that already is present in the polypropylene material. The proportion of component A is not particularly limited and may be in the range of 0.0001-5 wt. %, based on the total weight of polypropylene within the core layer, most preferably 0.01-1 wt. %, whereas the proportion of component B is 0.0002-5 wt. %, and most preferably 0.05-1 wt. %, during mixing. Preferably, the beta-nucleating agent is not a red dye.

Preferably, the propylene polymer and a beta-nucleating agent are brought together to form a masterbatch, which is then combined with some additional propylene polymer during or immediately prior to the melt extrusion. For example, in some embodiments, the core layer may contain BEPOL 022SP, a masterbatch of isotactic propylene homopolymer and beta-nucleating agent, available from Sunoco Chemicals. In other embodiments, the core layer may contain an impact propylene copolymer masterbatch with a beta-nucleating agent or the core layer may contain an impact propylene copolymer masterbatch with a beta-nucleating agent and an isotactic polypropylene. In still other embodiments, the core layer may contain: an (isotactic propylene)-ethylene heterophasic copolymer masterbatch with a beta-nucleating agent and an isotactic polypropylene; an impact polypropylene masterbatch with a beta-nucleating agent and a metallocene isotactic polypropylene; or an (isotactic propylene)-ethylene heterophasic copolymer, ethylene-propylene-ethylidene norbornene elastomer, isotactic polypropylene masterbatch with a beta-nucleating agent and an isotactic polypropylene that has a different m-pentad than the isotactic polypropylene in the isotactic polypropylene masterbatch.

One type of impact copolymer that may be used includes a polymer matrix with a dispersed rubbery copolymer phase. The matrix may be a homopolymer or random copolymer matrix. The rubbery copolymer phase may be a reactor blend of an amorphous rubber, a rubber-like polymer, which is normally an ethylene-propylene copolymer (rubber), and a semicrystalline ethylene copolymer.

By mixing the propylene polymer of the core layer, which predominantly contains the alpha-crystalline form of polypropylene, with the beta-nucleating agent of the core layer, high concentrations of the beta-crystalline form of polypropylene may be induced after the melting and subsequent cooling steps of the film-making process. The beta-crystalline form of polypropylene has a lower melting point and a lower density than the common alpha-crystalline form of polypropylene.

When present, the amount of beta-nucleating agent to be included in the core layer as cavitating agent is not particularly limited and may correspond to the desired degree of void formation upon stretching. In addition, the degree of opacity may be controlled by the amount of beta-nucleating agent included in the core layer. Preferred amounts of beta-nucleating agents may be from 0.0002 to 8 wt. % based on the weight of propylene polymer in the core layer, more preferably 0.005 to 2 wt. %, and 0.01 to 2 wt. %.

The core layer may further contain an optional another or secondary cavitating agent. For example, any conventional agent may be used as the optional secondary cavitating agent. For many preferred embodiments, the optional secondary cavitating agent may be an inorganic cavitating agent. Most preferably, the optional secondary cavitating agent may be calcium carbonate (CaCO₃), barium carbonate (BaCO₃), clay, talc, silica, mica, titanium dioxide (TiO₂), or mixtures thereof. In preferred embodiments of the core layer, a majority by volume of the cavitation is created via beta-nucleation. The secondary cavitating agent may create close to, but less than a majority of the cavitation. For the majority by volume of the cavities to be beta-cavitated cavities, the weight percent of secondary cavitating agent will typically not exceed 20 wt. % of the core layer, based upon the total weight of the core layer.

An organic cavitating agent may also be used as the optional secondary cavitating agent in the core layer. Preferably, however, the optional secondary cavitating agent is not an organic cavitating agent. Organic cavitating agents may “plate-out,” which may potentially lead to manufacturing downtime. Also, the cavitation quality from the use of organic cavitating agents may be sensitive to the viscosity change from the propylene polymer reclaims and output rate variations.

When present, the amount of secondary cavitating agent to be included in the core layer is not particularly limited and may be from 1 to 20 wt. %, based on the total weight of the core layer. Preferably, the core layer contains from 2 to 18 wt. % of secondary cavitating agent, most preferably from 3 to 15 wt. %, based on the total weight of the core layer. Exceeding about 20 wt. % of the core layer with the secondary cavitating agent may result in a film that has so many of the voids or cavities created by conventional cavitation that the benefits achieved through beta-cavitation are offset by the conventional cavitation and less than a majority by volume of the cavities may be beta-cavitated cavities.

Generally, the remainder of the core layer is made up of the propylene polymer(s) mentioned above, after the beta-nucleating agent and any optional additives, including the secondary cavitating agent, have been taken into account.

For some preferred embodiments, the core layer thickness may be at least 70% of the thickness of the entire film structure.

Embodiments of the multilayer film structures may also include those wherein another layer or layers besides the core layer have been cavitated. For example, another layer or layers of a film structure, such as an intermediate layer, may contain each of the same components as the core layer. Preferably, the first skin layer is not cavitated.

The film structures include a first skin layer on a side of the core layer. In some embodiments, the first skin layer preferably may be attached to the core layer through a first intermediate or tie layer that is provided on or directly on a side of the core layer.

The first skin layer comprises a polar polymer. As used herein, the term “polar polymer” means and refers to a class of polymers that comprise at least one wt. %, by weight of the polymer, of monomers having greater polarity and/or polarizability than propylene and having bonding functionality other than carbon and hydrogen, as components of the polymer backbone or sidechain. Preferred polar polymers comprise at least five wt. % of such monomers.

The polar polymer must be present in the first skin layer in an amount of at least five wt. %, based upon the weight of the total polymer in the first skin layer. For some embodiments, preferred concentrations of polar polymer are greater than about 20 wt. %. The incidental presence of polar polymers as a component of the first skin layer or concentrations of less than five wt. % are not considered as a polar polymer skin layer in this invention. Polymers having less than one wt. % of molecules having polarizing functional groups, and polar polymer concentrations of less than five wt. % are considered incidental concentrations and are not included as components of first skin layers of this invention. Preferred polar polymers may include but are not limited to those polymers having oxygen- and/or nitrogen-containing functional groups, such as but not limited to, carbonyl, amide, ester, carboxylic acid, carboxylic acid anhydride, and hydroxyl functional groups.

For example, the polar polymer of the first skin layer may be an ethylene-vinyl alcohol copolymer or a copolyester, such as a glycol-modified polyethylene terephthalate. The modification may be made by adding a second glycol, e.g., cyclohexane dimethanol (CHDM), during the polymerization stages. The polar polymer of the first skin layer may be a homopolymer of lactic acid, or a copolymer of lactic acid and a hydroxycarboxylic acid. The hydroxycarboxylic acid may be a glycolic acid, 3-hydroxybutyric acid, 4-hydroxybutyric acid, 4-hydroxyvaleric acid, 5-hydroxyvaleric acid, 6-hydroxycaproic acid, or a mixture thereof. Preferably, the first skin layer contains an ethylene-vinyl alcohol copolymer.

Commercially available polar polymers that are suitable for use as the first skin layer include EASTAR 6763, a glycol-modified polyethylene terephthalate produced by Eastman Chemical Company, and EVAL G176B, an ethylene-vinyl alcohol copolymer available from Eval Americas.

The polar polymer of the first skin layer may promote adhesion to the surface of the first skin layer. For example, the polar polymer of the first skin layer may promote the adhesion of a vapor-deposited metal, e.g., aluminum, to the surface of the first skin layer. The polar polymer of the first skin layer may also promote enhanced adhesion and receptivity to inks as compared to non-polar-polymer skin layers.

Without being bound to any theory, it is believed that polar polymers, such as those containing oxygen or nitrogen, as an integral component of the polymer backbone or side chain, may provide better adhesion of, for example, coatings and vapor-deposited metals/oxides than would a polyolefin surface that does not contain such functional group as an integral component of the polymer backbone or side chain.

Surface treatment, such as corona or plasma treatment, of a polyolefin surface that does not contain a polar polymer as an integral component of the polymer backbone or side chain, may increase the surface energy by oxidizing the surface and depositing polar oxygen- or nitrogen-containing functions on the surface. Wettability may thereby be improved. Without being bound to any theory, it is believed that the polar oxygen- or nitrogen-containing functions provided by mere surface treatment on otherwise non-polar polymer skin layers are only loosely bound to the surface and thus do not promote adhesion and persistence as well as may be desired in some applications. According to this invention, the polar polymers of the first skin layer, on the other hand, deliver more “bound” polar, e.g., oxygen/nitrogen, species that may improve both wettability and adhesion to metal layers, coatings, adhesives, and laminations.

The polar polymer of the first skin layer may provide a mechanism for improving the barrier properties and reducing the permeability in applications where high moisture, odor, and/or gas permeability is undesirable. Surprisingly, the film structures display improved barrier performance despite the fact that the polar polymers which may be used in the first skin layer may otherwise be considered poor barriers in the art. For example, certain film structure embodiments may have a WVTR of less than 6.0 (g/[m²·day]), preferably a WVTR of less than 5.0 (g/[m²·day]).

The film structures may include a second skin layer on a side of the core layer opposite the first skin layer. The component(s) of the second skin layer is not particularly limited and may include, for example, any of the film-forming thermoplastic polymers. Examples of suitable film-forming thermoplastic polymers include the polyolefins, such as propylene polymers and ethylene polymers.

In certain embodiments, the second skin layer contains an isotactic propylene homopolymer, syndiotactic propylene homopolymer, isotactic propylene impact copolymer, syndiotactic propylene impact copolymer, propylene homopolymer. Other embodiments may also contain a beta-nucleating agent, and/or a propylene impact copolymer. For example, the impact copolymer may be TI-4040-G, an impact propylene copolymer available from Sunoco. TI-4040-G contains 17% ethylene-propylene rubber content.

In other embodiments, the second skin layer may be a sealable skin layer, such as a heat-sealable skin layer. For example, the second skin layer may contain propylene-ethylene copolymer, propylene-ethylene-butene-1 terpolymer (such as XPM7510, an ethylene-propylene-butene-1 terpolymer, available from Japan Polypropylene Corporation), propylene-α-olefin copolymer, or metallocene-catalyzed ethylene-α-olefin copolymer.

In still other embodiments, the second skin layer may be a sealable skin layer containing a polymer such as an (isotactic propylene)-α-olefin copolymer, a (syndiotactic propylene)-α-olefin copolymer, an ethylene-vinyl acetate copolymer (EVA), an ethylene-methacrylic acid copolymer (EMA), an ethylene-acrylic acid copolymer (EAA), an ethylene-methylacrylate-acrylic acid terpolymer (EMAAA), an ethylene-alkyl acrylate copolymer, an ionomer such as ethylene-alkyl acrylate-acrylic acid Zn salt or Na salt, a metallocene-catalyzed plastomer, a very low density polyethylene (VLDPE), for example, having a density of 0.89 to 0.915 g/cc, an ethylene-(methyl acrylate)-(glycidyl methacrylate) terpolymer, or an ethylene-(glycidyl methacrylate) copolymer. The second skin layer may contain a mixture of any of the foregoing polymers.

The second skin layer, if present, may be provided directly on a side of the core layer, such as the first side, or the second skin layer, if present, may be provided on a side of the core layer with one or more intermediate layers between the core layer and the second skin layer.

The component(s) of the first intermediate layer and any additional intermediate layer which may be optionally included, is not particularly limited and may include any of the film-forming thermoplastic polymers. Suitable film-forming thermoplastic polymers for the intermediate layer(s) include polyolefins, such as polypropylene, syndiotactic polypropylene, polypropylene copolymers, low density polyethylene (LDPE), linear low density polyethylene (LLDPE), medium density polyethylene (MDPE), high density polyethylene (HDPE), ethylene copolymers, such as, for example, an ethylene-vinyl acetate copolymer (EVA), nylons, polymers grafted with functional groups, blends of these, etc. For example, an intermediate layer may contain a polyolefin grafted with a functional group, such as an ADMER resin, a maleic anhydride-grafted polypropylene available from Mitsui Petrochemical Industries Ltd. (Tokyo, Japan).

Preferably, the first intermediate layer, i.e., the intermediate layer between the core layer and the first skin layer, may have an adhesion-promoting function. Thus, it may preferably contain, for example, a maleic anhydride-grafted propylene polymer, alone or in combination with another polymer, such as an isotactic propylene homopolymer. Optionally, a second intermediate layer, i.e., an optional intermediate layer between the core layer and the second skin layer, may contain a beta-nucleating agent as a primary cavitating agent (e.g., to create greater than about 50 volume percent beta-cavities), a secondary cavitating agent (e.g., to create less than about 50 volume percent beta-cavities), or a blend thereof.

Films according to the present invention may be characterized in terms of the process for making such films. A multilayer film according to the present invention may be prepared according to a method comprising the steps of; (a) forming a film structure, such as by coextrusion, comprising (i) a core layer comprising a propylene polymer, and (ii) a first skin layer comprising a polar polymer; (b) creating at least some beta-form propylene polymer in the core layer; and (c) thereafter, heating and/or orienting the formed film structure comprising the at least some beta-form propylene polymer to convert at least a portion of the at least some beta-form propylene polymer into alpha-form propylene polymer, cavities are created within the core layer and a majority by volume of the cavities are beta-cavities.

The method for making the subject films may further comprise the step of forming with the core layer and the first skin layer, such as by coextrusion, a first intermediate layer positioned between the core layer and the first skin layer. In one preferred embodiment, the method further comprises the step of mixing a beta-nucleating agent with the propylene polymer of the core layer prior to extruding or forming the core layer to promote growth of beta-form polypropylene crystals.

After extruding the layers of the multilayer film and creating beta-form polypropylene crystals, a preferred process comprises the step of heating the core layer and/or orienting the coextruded film structure from 4 to 6 times in the machine direction and from 4 to 10 times in the transverse direction to impart stress and/or heat within the core layer. The heat and/or stress may facilitate conversion of the beta-form polypropylene to the alpha-form polypropylene.

One or both outer surfaces of the film structure may be surface-treated. If the structure consists of a core layer, a first intermediate layer and a first skin layer, the outer surfaces would be the surface of the first skin layer opposite the first intermediate layer and the surface of the core layer opposite the first intermediate layer. If the structure contains a core layer, a first intermediate layer, and at least first and second skin layers, the outer surfaces would be the surfaces of the first and second skin layers that are respectively opposite the first intermediate layer and the core layer. The surface-treatment may be effected by any of various techniques, including, for example, flame treatment, corona treatment, and plasma treatment. Preferably, the second side, i.e., the outer surface, of the first skin layer is surface-treated.

In certain embodiments, the outer surface or surfaces of the film structure may be metallized. Metallization can be effected by vacuum deposition, or any other metallization technique, such as electroplating or sputtering. The metal may be aluminum, or any other metal capable of being vacuum deposited, electroplated, or sputtered, such as, for example, gold, silver, zinc, copper, magnesium or iron. Preferably, the second side, i.e., the outer surface, of the first skin layer is metallized. Certain metallized film structure embodiments may have a WVTR of less than 0.20 (g/[m²·day]), preferably a WVTR of less than 0.15 (g/[m²·day]), and an OTR of less than 1.5 (cm³/[m²·day·atm]), preferably an OTR of less than 0.20 (cm³/[m²·day·atm]).

One or both outer surfaces of the film structure may be coated with a coating, such as a primer coating, e.g., a polyvinylidene chloride (PVdC), acrylic, or silicon oxide (SiOₓ) coating, a water-based coating, or a coating containing inorganic particles, such as clay, calcium carbonate, or titanium oxide, dispersed in a binder, such as an iminated butyl acrylate copolymer. Coatings may be used to provide advantages such as enhanced gloss and enhanced compatibility with manufacturing processes and machinery.

Certain embodiments of the film structures may receive an image, such as, for example, printed matter, on an outer surface(s) of the film structure, preferably the second side of the first skin layer. In other embodiments, priming the outer surface(s) of the skin layer to receive an image may render it even more receptive to the image. The outer surface(s) of the film structure may receive the image by any suitable means, including, for example, letterpress, offset printing, screen-printing, spraying, electrostatic, electrographic printing, and electrophotographic (including laser printing and xerography) methods. Other imaging methods contemplated include, but are not limited to, thermal printing including hot stamping, direct thermal printing, dye diffusion printing, and thermal mass transfer printing, lithographic printing, flexographic printing, gravure or rotogravure printing, valley printing, roll-leaf printing, ink-jet printing, and spanishing.

Laminated film structures may be prepared including a first film structure. The first film structure may contain a core layer having first and second sides. The core layer may contain a propylene polymer and a beta-nucleating agent. The core layer is a cavitated layer. The first film structure may also contain a first intermediate layer having first and second sides. The first side of the first intermediate layer is on the second side of the core layer. The first film structure may further contain a first skin layer having first and second sides. The first side of the first skin layer is on the second side of the first intermediate layer. The first skin layer may contain a polar polymer.

The laminated film structure may also include an adhesive layer on the second side of the first skin layer of the first film structure. The adhesive for laminating is not particularly limited and may contain, for example, a low density polyethylene. Commercially available adhesives include, for example, MARFLEX LDPE 1017, a low density polyethylene produced by Chevron Phillips Chemical Company LLC.

The laminated film structure may further include a second structure on the adhesive layer. The second structure may be a monolayer or multilayer film structure, or the second structure may be a different material, such as, for example, paper.

Methods of manufacturing the laminated film structures are not particularly limited and may include, for example, extrusion lamination, as in Examples 5 and 6 below, or adhesive lamination, where the adhesive is applied from solution to one of the first and second structures, and the first and second structures are thereafter adhered together.

In order to modify or enhance certain properties of the film structure, it is possible for one or more of the layers to contain dispersed therein, appropriate additives in effective amounts. Preferred additives include anti-blocks, anti-static agents, anti-oxidants, anti-condensing agents, co-efficient of friction (COF) modifiers (slip agents), processing aids, colorants, clarifiers, foaming agents, flame retardants, photodegradable agents, UV sensitizers or UV blocking agents, crosslinking agents, ionomers and any other additives known to those skilled in the art.

For example, in certain embodiments, it may be desirable to include a coloring agent, such as a pigment or dye, in one or more of the layers, including the second skin layer or the intermediate layer between the core layer and the second skin layer.

As another example, in certain embodiments, a skin layer of the film structure may include dispersed therein one or more anti-block agents to prevent “grabbing” of the structure on machine surfaces, one or more slip agents to provide better slip on heated metal surfaces, and/or one or more anti-static agents to maximize sheetability. Specific examples of anti-block agents include coated silica, uncoated silica and crosslinked silicone. Specific examples of slip agents include silicone oils. Specific examples of anti-static agents include alkali metal sulfonates, tertiary amines and the like.

Methods of manufacturing the film structures are not particularly limited. For example, a melt(s) corresponding to the individual layer(s) of the film structure may be prepared. The melts may be cast-extruded or coextruded into a sheet using a flat die or blown-extruded or coextruded using a tubular die. The sheets may then be oriented either uniaxially or biaxially by known stretching techniques. For example, the sheet may be uniaxially oriented from four to eight times of orientation ratio.

While the film structures may be made by any method, preferably the multilayer film structures are made by coextrusion and biaxial stretching of the layer(s). The biaxial orientation may be accomplished by either sequential or simultaneous orientation, as is known in the art. In particularly preferred embodiments, the film structure is oriented from four to six times in the machine direction and from four to ten times in the transverse direction.

During the manufacturing process, if the cast temperature is set too low, i.e., quick quenching, the alpha crystalline form may dominate and the beta-crystalline form may account for less than 50% by volume or the total cavity volume. Therefore, the film structures are preferably manufactured by setting the cast roll temperature at above 85° C., more preferably from 90° C. to 100° C. The nip roll against the cast roll is preferably set to a range of from 93° C. to 120° C. At these settings, beta-crystalline formation is maximized. Though the films can be cast with or without a waterbath, preferably the film is cast without a waterbath.

One example of a method of manufacturing a film structure may include coextruding a multilayer film comprising: a core layer (a) having first and second sides, wherein the core layer may contain a propylene polymer and the core layer is a beta-cavitated layer; a first skin layer (b) having first and second sides, wherein the first side of first skin layer (b) contains a polar polymer. Preferably, the multilayer film also comprises a first intermediate layer (c) having first and second sides, wherein the first side of first intermediate layer (c) may be on the second side of core layer (a). Preferably, the core layer also comprises a beta-nucleating agent to create the beta-form polypropylene crystals to facilitate creation of voids or beta-cavitation through beta- to alpha-polymer crystal conversion. The coextruded multilayer film may then be oriented from, for example, 4 to 6 times in the machine direction and from, for example, 4 to 10 times in the transverse direction, at an orientation temperature of, for example, at least 85° C. Many preferred embodiments may also comprise a metal layer and/or a coating, such as a barrier-enhancing coating, on the surface of the first skin layer opposite the core layer and/or the first intermediate layer.

In another embodiment, a method for preparing a multilayer film comprises the steps of (a) forming, such as by coextruding or laminating, a film structure comprising (i) a core layer comprising a propylene polymer and (ii) a first skin layer comprising a polar polymer; (b) creating at least some beta-form propylene polymer in the core layer; and (c) thereafter, heating and/or orienting the coextruded film structure comprising the beta-form propylene polymer to convert at least a portion of the beta-form propylene polymer into alpha-form propylene polymer. The method may further comprise the step of coextruding with the core layer and the first skin layer, a first intermediate layer between the core layer and the first skin layer. In still other embodiments, the method may comprise the step of mixing a beta-nucleating agent with the propylene polymer of the core layer prior to forming the core layer.

The film structures may have a density of from 0.20 to 0.95 g/cm³, preferably from 0.20 to 0.85 g/cm³, more preferably from 0.20 to 0.60 g/cm³.

The film density values reported herein may be measured by a method of first measuring the yield of the film. Specifically, 80 pieces of film from a film sample are cut, each having a diameter of 4 inches (10.16 cm). The total area of the 80 pieces is then calculated. The weight of the 80 pieces (in grams) is then measured. The yield of the film (cm²/gram) will equal the total specimen area (cm²) over the specimen weight (gram).

After measuring the film yield, the film thickness may be measured with a laser beam. For example, the film thickness (mil) may be measured with a Model 238-20, available from Beta LaserMike Company. The thickness unit value is converted from mils to centimeters. This non-contact method for measuring film thickness may be especially suitable for microvoided film structures because it may avoid the error that sometimes arises from mechanical compression on the film from a conventional micrometer.

Finally, the density (gram/cm³) may be calculated from the inverse (1/X) of the film yield (cm²/gram) times the film thickness (cm).

The film structures may have uniform opacity. Preferably, the light transmission of the film, as measured by ASTM D1003, is less than 60%, more preferably less than 40%, even more preferably less than 20%, and most preferably less than 10%.

Total thickness of the film structure is not particularly limited. For certain applications, the overall thickness may be greater than 5 μm optical gauge. Preferably, a film structure may have an overall thickness of from 10 μm to 250 μm optical gauge, preferably 10 μm to 150 μm, more preferably from 18 μm to 100 μm optical gauge, even more preferably 18 to 60 μm, and most preferably from 25 μm to 50 μm optical gauge. Preferably, the thickness of each layer, as measured for the optical gauge, may range from 0.5 μm to 3 μm, more preferably from 0.5 μm to 1.5 μm, for the first skin layer; from 0.5 μm to 3 μm, more preferably from 0.5 μm to 1.5 μm, for the second skin layer (if present); and from 0.25 μm to 3 μm, more preferably from 0.5 μm to 3 μm, for the first intermediate layer and any other intermediate layer which may be present. The remainder of the film structure thickness in each case up to the overall thickness is made up of the core layer.

End-use applications for the film structures are not particularly limited. The films according to this invention may be used in substantially any application where a relatively high-barrier packaging film may be useful. For example, embodiments may provide a packaged article encased in a film structure. The packaged article may include generally any article of commerce. In many preferred applications, an article of commerce includes fast moving consumable goods, e.g., goods that are consumed and replenished by the consumer within a few months, such as food products, health and beauty care products, medical products, and any other product or good, wherein high-barrier packaging, freshness and/or modified atmosphere packaging as may be provided by films according to this invention may be desired. When used to package an article, the packaging film according to this invention may at least partially encase or surround the article. A preferred embodiment of a packaging film according to this invention may contain: a core layer (a) having first and second sides, wherein the core layer may contain a propylene polymer and a beta-nucleating agent primary cavitating agent, and the core layer may be a cavitated layer; a first intermediate layer (b) having first and second sides, wherein the first side of first intermediate layer (b) may be on the second side of core layer (a); and a first skin layer (c) having first and second sides, wherein the first side of first skin layer (c) may be on the second side of first intermediate layer (b), and first skin layer (c) may contain a polar polymer. The packaging film may be biaxially oriented.

The following specific examples further illustrate the invention. In the examples:

EASTAR 6763 refers to a glycol-modified polyethylene terephthalate;

ADMER refers to a maleic anhydride-grafted polypropylene;

PP4612E2 refers to an isotactic propylene homopolymer;

BEPOL 022SP refers to a masterbatch of isotactic propylene homopolymer and beta-nucleating agent;

PP4712E1 refers to an isotactic propylene homopolymer;

EVAL G176B refers to an ethylene-vinyl alcohol copolymer; and

XPM 7510 Refers to an ethylene-propylene-butene-1 terpolymer.

### EXAMPLE 1

A four-layer film having a total thickness of 25 μm (optical gauge) was made via tenter-frame sequential orientation at 4.8 times in MD orientation and 8 times in TD orientation and had the following structure (with individual layer thicknesses also provided). The second side (outer surface) of the first skin layer received corona surface treatment.

| | |
|---|---|
| First skin layer | EASTAR 6763; 1 μm |
| First intermediate layer | ADMER; 3 μm |
| Core layer | 80 wt. % PP4612E2 + 15 wt. % BEPOL 022SP + |
| | 5 wt. % PP/CaCO₃ masterbatch (70 wt. % |
| | CaCO₃); 20 μm |
| Second skin layer | PP4712E1; 1 μm |

### EXAMPLE 2

A four-layer film having a total thickness of 25 μm (optical gauge) was made via tenter-frame sequential orientation at 4.8 times in MD orientation and 8 times in TD orientation and had the following structure (with individual layer thicknesses also provided). The second side (outer surface) of the first skin layer received corona surface treatment.

| | |
|---|---|
| First skin layer | EVAL G176B; 1 μm |
| First intermediate layer | 50 wt. % ADMER + 50 wt. % PP4612E2; 3 μm |
| Core layer | 80 wt. % PP4612E2 + 15 wt. % BEPOL 022SP + |
| | 5 wt. % PP/CaCO₃ masterbatch (70 wt. % |
| | CaCO₃); 20 μm |
| Second skin layer | PP4712E1; 1 μm |

### COMPARATIVE EXAMPLE 1

A four-layer film having a total thickness of 25 μm (optical gauge) was made via tenter-frame sequential orientation at 4.8 times in MD orientation and 8 times in TD orientation and had the following structure (with individual layer thicknesses also provided). The second side (outer surface) of the first skin layer received corona surface treatment.

| | |
|---|---|
| First skin layer | XPM 7510; 1 μm |
| First intermediate layer | 50 wt. % ADMER + 50 wt. % PP4612E2; 3 μm |
| Core layer | 80 wt. % PP4612E2 + 15 wt. % BEPOL 022SP + |
| | 5 wt. % PP/CaCO₃ masterbatch (70 wt. % |
| | CaCO₃); 20 μm |
| Second skin layer | PP4712E1; 1 μm |

### EXAMPLE 3

The film structure described in Example 1 was thereafter metallized on the second side (outer surface) of the first skin layer with aluminum in a commercial vacuum metallizer unit to achieve an optical density of 3.2.

### EXAMPLE 4

The film structure described in Example 2 was thereafter metallized on the second side (outer surface) of the first skin layer with aluminum in a commercial vacuum metallizer unit to achieve a film having an optical density of 2.9.

### EXAMPLE 5

A laminated film structure was prepared by preparing a first film structure in the same manner as the film structure of Example 3 and laminating thereto on the metallized second side (outer surface) a 17.5 μm total thickness, three-layer biaxially oriented polypropylene film. The film structures were laminated using 10 lbs per ream low density polyethylene.

### EXAMPLE 6

A laminated film structure was prepared in the same manner as in Example 5, except that the first film structure was prepared in the same manner as the film structure of Example 4.

WVTRs (g/[m²·day]) were measured for the film structures of Examples 1 and 2 and Comparative Example 1. The results are shown in Table 1 below. Surprisingly, film structures (e.g., Examples 1 and 2) having first skin layers containing a polar polymer displayed better moisture barrier properties than the film structure having a first skin layer containing a terpolymer, despite the fact that both a glycol-modified polyethylene terephthalate and an ethylene-vinyl alcohol copolymer are generally considered poorer moisture barriers than terpolymers.

TABLE 1

| | Actual WVTR |
|---|---|
| Ex. 1 | 5.6 ± 0.1 |
| Ex. 2 | 4.6 ± 0.06 |
| Comp. Ex. 1 | 6.2 ± 0.2 |

Tables 2 and 3 below show barrier results (WVTR in (g/[m²·day]); OTR in (cm³/[m²·day·atm]) for metallized film structures (Examples 3 and 4) and laminated, metallized film structures (Examples 5 and 6).

TABLE 2

| | WVTR | OTR |
|---|---|---|
| Ex. 3 | 0.10 | 1.2 |
| Ex. 4 | 0.17 | 0.18 |

TABLE 3

| | WVTR | OTR |
|---|---|---|
| Ex. 5 | 0.02 | 0.88 |
| Ex. 6 | 0.08 | 0.03 |

Test Procedures

Oxygen transmission data was obtained using a MOCON OXTRAN 1000 or MOCON OXTRAN 2/20 unit at 73° F., 0% relative humidity with the metallized surfaces facing away from the driving force. Moisture barrier data was obtained using a MOCON W700 unit and is reported at 100° F., 90% relative humidity with the polar or metallized surfaces facing away from the driving force.

While the invention has been described in detail and with reference to specific embodiments thereof, it will be apparent to one of ordinary skill in the art that various changes and modifications can be made therein without departing from the spirit and scope of the invention. The Examples recited herein are demonstrative only and are not meant to be limiting. Further embodiments are within the following claims.

1. A film structure, comprising:
(a) a core layer having first and second sides, wherein the core layer comprises a propylene polymer and the core layer (a) is beta-cavitated; and
(b) a first skin layer having first and second sides, wherein the first side of first skin layer (b) is on the second side of core layer (a) and first skin layer (b) comprises a polar polymer.

2. The film structure of claim 1, further comprising:
(c) a first intermediate layer having first and second sides, wherein the first intermediate layer is between the core layer (a) and the first skin layer (b).

3. The film structure of claim 1, wherein the core layer (a) further comprises a beta-nucleating agent.

4. The film structure of claim 1, wherein the propylene polymer of core layer (a) is selected from the group consisting of isotactic propylene homopolymer, isotactic propylene impact copolymer, isotactic propylene heterophasic copolymer, and mixtures thereof.

5. The film structure of claim 1, wherein the propylene polymer of core layer (a) comprises a mixture of two isotactic propylene homopolymers having different m-pentad fractions.

6. The film structure of claim 1, wherein the polar polymer of first skin layer (c) comprises a polymer selected from the group consisting of an ethylene-vinyl alcohol copolymer and a polyester.

7. The film structure of claim 6, wherein the polar polymer of first skin layer (b) comprises a polyester, and the polyester is a glycol-modified polyethylene terephthalate.

8. The film structure of claim 6, wherein the polar polymer of first skin layer (b) comprises a polyester, and the polyester is a lactic acid homopolymer.

9. The film structure of claim 6, wherein the polar polymer of first skin layer (b) comprises a polyester, and the polyester is a copolymer of lactic acid and a hydroxycarboxylic acid.

10. The film structure of claim 1, wherein the light transmission of the film structure is less than 60%.

11. The film structure of claim 10, wherein the light transmission of the film structure is less than 40%.

12. The film structure of any one of claims 1 to 9, wherein core layer (a) further comprises a secondary cavitating agent.

13. The film structure of claim 12, wherein the film structure is oriented in at least one direction and the secondary cavitating agent comprises an inorganic cavitating agent selected from the group consisting of calcium carbonate (CaCO₃), barium carbonate (BaCO₃), clay, talc, silica, mica, titanium dioxide (TiO₂) and mixtures thereof.

14. The film structure of claim 2, wherein first intermediate layer (c) comprises a polymer selected from the group consisting of a maleic anhydride-grafted propylene homopolymer or copolymer, a high density polyethylene, and an ethylene-vinyl acetate copolymer.

15. The film structure of claim 14, wherein first intermediate layer (c) comprises a maleic anhydride-grafted propylene homopolymer or copolymer.

16. The film structure of claim 1, wherein the film structure further comprises a second skin layer (d) on a side of the core layer (a) opposite the first skin layer (b).

17. The film structure of claim 1, wherein the film structure further comprises:
a second skin layer (d) on a side of the core layer (a) opposite the first skin layer (b); and
a second intermediate layer (e) between the core layer (a) and the second skin layer (d).

18. The film structure of claim 1, wherein the film structure is a biaxially oriented film structure that has been oriented from 4 to 6 times in the machine direction and from 4 to 10 times in the transverse direction.

19. The film structure of claim 2, wherein the film structure has a water vapor transmission rate (WVTR) of less than 6.0 (g/[m²·day]).

20. The film structure of claim 19, wherein the film structure has a water vapor transmission rate (WVTR) of less than 5.0 (g/[m²·day]).

21. The film structure of claim 1, wherein the film structure is oriented in at least one direction.

22. The film structure of claim 21, wherein after the film structure is oriented, the core layer comprises cavities and a majority by volume of the cavities result from beta-cavitation.

23. The film structure of claim 12, wherein the core layer is cavitated by both beta-cavitation and the secondary cavitating agent and the secondary cavitating agent comprises at least one weight percent and not greater than 35 weight percent of the core layer; and
wherein a majority by volume of the cavities are created by beta-cavitation.

24. The film structure of claim 1, wherein the first skin layer comprises at least five weight percent polar polymer, based upon the weight of the first skin layer.

25. The film store of claim 1, wherein the first skin layer comprises at least twenty weight percent polar polymer, based upon the weight of the first skin layer.

26. The film structure of claim 1, wherein the polar polymer comprises at least one weight percent by weight of the polymer of monomers having greater polarity and/or polarizability than propylene and having bonding functionality other than carbon and hydrogen.

27. The film structure of claim 1, wherein the polar polymer comprises at least five weight percent by weight of the polymer of monomers having greater polarity and/or polarizability than propylene and having bonding functionality other than carbon and hydrogen.

28. The film structure of claim 1, wherein the core layer further comprises a beta-nucleating agent and the beta-nucleating agent is present an amount of from 0.0002 weight percent to 8 weight percent, based upon the weight of propylene polymer in the core layer.

29. The film structure of claim 1, wherein the second side of first skin layer (b) has been surface-treated by a surface treatment selected from the group consisting of flame treatment, corona treatment, and plasma treatment.

30. The film structure of claim 1, wherein the second side of the first skin layer (b) further comprises at least one of a coating and a metal layer.

31. The film structure of claim 1, wherein the polar polymer comprises at least five wt. % of the first skin layer, based upon the weight of the total polymer in the first skin layer.

32. The film structure of claim 1, wherein the polar polymer comprises at least 20 wt. % of the first skin layer, based upon the weight of the total polymer in the first skin layer.

33. A multilayer film prepared according to a method comprising the steps of:
(a) forming a film structure comprising;
(i) a core layer comprising a propylene polymer; and
(ii) a first skin layer comprising a polar polymer;
(b) creating at least some beta-form propylene polymer in the core layer; and
(c) heating and/or orienting the film structure comprising the beta-form propylene polymer to convert at least a portion of the beta-form propylene polymer into alpha-form propylene polymer, the core layer having at least a majority by volume of cavities formed in the core layer resulting from conversion of beta-form polypropylene to alpha-form polypropylene.

34. The multilayer film of claim 33, wherein the method father comprises the step of:
forming with the core layer and the first skin layer, a first intermediate layer between the core layer and the first skin layer.

35. The multilayer film of claim 33, wherein the method further comprises the step of:
mixing a beta-nucleating agent with the propylene polymer of the core layer prior to forming the core layer.

36. The multilayer film of claim 33, wherein the method further comprises the step of:
selecting the propylene polymer of the core layer from the group consisting of isotactic propylene homopolymer, isotactic propylene impact copolymer, isotactic propylene heterophasic copolymer, and mixtures thereof.

37. The multilayer film of claim 33, wherein the method further comprises the step of:
selecting the polar polymer of the skin layer from the group consisting of an ethylene-vinyl alcohol copolymer and a polyester.

38. The multilayer film of claim 33, wherein the method further comprises the step of:
selecting the polar polymer of the skin layer from the group consisting of a glycol-modified polyethylene terephthalate, a lactic acid homopolymer, and a copolymer of lactic acid and a hydroxycarboxylic acid.

39. The multilayer film of claim 33, wherein the method further comprises the step of:
selecting the first intermediate layer from the group consisting of a maleic anhydride-grafted propylene homopolymer or copolymer, a high density polyethylene, and an ethylene-vinyl acetate copolymer.

40. The multilayer film of claim 33, wherein the method flier comprises the step of:
coextruding with the core layer and the first skin layer, a second skin layer on a side of the core layer opposite the first skin layer.

41. The multilayer film of claim 33, wherein the step of heating and/or orienting the film structure further comprises orienting the film structure from 4 to 6 times in the machine direction and from 4 to 10 times in the transverse direction.

42. The multilayer film of claim 33, wherein the method further comprises the step of:
surface treating a side of the first skin layer opposite the core layer with a surface treatment selected from the grouts consisting of flame treatment, corona treatment, and plasma treatment.

43. The multilayer film of claim 33, wherein the method further comprises the step of:
applying at least one of a coating and a metal layer to the side of the first skin layer opposite the core layer.

44. A metallized, film structure, comprising:
(a) a core layer having first and second sides, wherein the core layer comprises a propylene polymer and the core layer is beta-cavitated;
(b) a first skin layer having first and second sides, wherein the first skin layer comprises a polar polymer; and
(c) a first intermediate layer having first and second sides, wherein the first intermediate layer is between the core layer (a) and the first skin layer (b); and
wherein the film structure is oriented after extrusion to create an oriented film structure; and
wherein the oriented film structure further comprises at least one of a coating and a metal layer on the second side of first skin layer (b).

45. The metallized film structure of claim 44, wherein the first skin layer (b) further comprises a beta-nucleating agent.

46. The metallized film structure of claim 44, wherein the polar polymer of first skin layer (b) comprises a polymer selected from the group consisting of an ethylene-vinyl alcohol copolymer, a polyester, a glycol-modified polyethylene terephthalate, a lactic acid homopolymer, a copolymer of lactic acid and a hydroxycarboxylic acid.

47. The film structure of claim 44, wherein the film structure has a water vapor transmission rate (WVTR) of less than 0.20 (g/[m²·day]).

48. The film structure of claim 44, wherein the film structure has an oxygen transmission rate (OTR) of less than 1.5 (cm³/[m²-day-atm]).

49. A laminated film structure, comprising:
(A) a first film structure comprising:
(a) a core layer having first and second sides, wherein core layer (a) comprises a propylene polymer, a beta-nucleating agent, and cavities, wherein a majority by volume of the cavities are beta-cavitated cavities;
(b) a first skin layer having first and second sides, wherein the first side of first skin layer (b) comprises a polar polymer;
(c) a first intermediate layer having first and second sides, wherein the first side of first intermediate layer (c) is on the second side of core layer (a) and between the core layer (a) and the first skin layer (b); and
wherein the first film structure is oriented after coextrusion;
(B) an adhesive layer on the second side of first skin layer (b) of the first film structure; and
(C) a second structure on the adhesive layer and on the side of the adhesive layer opposite the first skin layer (b).

50. The laminated film structure of claim 49, wherein the polar polymer of first skin layer (b) comprises a polymer selected from the group consisting of an ethylene-vinyl alcohol copolymer and a polyester.

51. The laminated film structure of claim 49, wherein the adhesive comprises low density polyethylene.

52. The laminated film structure of claim 49, wherein the second structure comprises at least one of a monolayer film structure, a multilayer film structure, and paper.

53. A method of preparing a film structure, the method comprising the steps of
(A) forming a multilayer film comprising;
(a) a core layer having first and second sides, wherein the core layer comprises a propylene polymer and a beta-nucleator cavitating agent;
(b) a first skin layer having first and second sides, the first skin layer (b) comprising a polar polymer; and
(c) a first intermediate layer having first and second sides, wherein the first side of first intermediate layer (c) is between the core layer (a) and the first skin layer (b); and
(B) orienting the multilayer film from 4 to 6 times in the machine direction and from 4 to 10 times in the transverse direction, at an orientation temperature of at least 85° C., and creating cavities within the core layer, wherein a majority by volume of the cavities are beta-cavitated cavities.

54. A packaged article encased in a film structure, comprising:
an article of commerce; and
a packaging film at least partially encasing the article of commerce, the packaging film comprising:
(a) a core layer having first and second sides, wherein the core layer comprises a propylene polymer and a beta-nucleating agent primary cavitating agent, wherein core layer (a) is a beta-cavitated layer comprising cavities, and a majority by weight of the cavities are beta-cavitated cavities;
(b) a first skin layer having first and second sides, wherein the first skin layer (b) comprises a polar polymer;
(c) a first intermediate layer having first and second sides, wherein the first intermediate layer (c) is between the core layer (a) and the first skin layer (b); and
wherein the packaging film is biaxially oriented.

55. The packaged article of claim 54, wherein the article of commerce comprises a food product.

56. The packaged article of claim 54, wherein the article of commerce comprises a medical product.

57. A method of preparing a multilayer film, the method comprising the steps of:
(a) forming a film structure comprising;
(i) a core layer comprising a propylene polymer; and
(ii) a first skin layer comprising a polar polymer;
(b) creating at least some beta-form propylene polymer in the core layer; and
(c) heating and/or orienting the film structure comprising the beta-form propylene polymer to convert at least a portion of the beta-form propylene polymer into alpha-form propylene polymer and create cavities within the core layer, such that a majority by volume of the cavities in the core layer result from conversion of the beta-form polypropylene to the alpha-form polypropylene.

58. The method of claim 57, wherein the method further comprises the step of:
forming with the core layer and the first skin layer, a first intermediate layer between the core layer and the first skin layer.

59. The method of claim 57, wherein the method further comprises the step of:
mixing a beta-nucleating agent with the propylene polymer of the core layer prior to forming the core layer.
